(19) United States
(12) Patent Application Publication
(10) Pub. No.: US 2009/0024806 A1
(43) Pub. Date: Jan. 22, 2009

(54) STORAGE DEVICE, STORAGE CONTROLLER, SYSTEM, METHOD OF STORING DATA, METHOD OF READING DATA AND FILE SYSTEM

(76) Inventors: CHRISTOPH BILGER, Munich (DE); Rex Kho, Holzkirchen (DE); Achim Schramm, Munich (DE); Martin Maier, Diessen (DE); Yann Zinzius, Unterhaching (DE); Armin Kohlhase, Neubiberg (DE)

Correspondence Address: PATTERSON & SHERIDAN, LLP;Gero McClellan / Qimonda, 3040 POST OAK BLVD.,, SUITE 1500, HOUSTON, TX, 77056, US

(21) Appl. No.: 11/781,039

(22) Filed: Jul. 20, 2007

(51) Int. Cl. G06F 13/38; G06F 17/30

(52) U.S. Cl. 711/154; 707/101; 707/E17.006; 711/E12.002

(57) ABSTRACT

A storage device comprises a storage location, an interface coupled to the storage location, and a data conversion circuit coupled to the storage location and to the interface. The interface is configured for an exchange of data between the storage device and external circuitry coupled to the interface. The data conversion circuit is configured for converting data from a first data format to a second data format. The data conversion circuit is configured to convert at least one of data read from the storage location before they are transferred to the interface, and data received via the interface before they are written to the storage location.

### BRIEF DESCRIPTION OF THE DRAWINGS

The features of the embodiments of the present invention will become clear from the following description, taking in conjunction with the accompanying drawings. It is to be noted, however, that the accompanying drawings illustrate only typical embodiments of the present invention and are, therefore, not to be considered limiting of the scope of the invention. The present invention may admit other equally effective embodiments.

FIG. 1 shows a schematic representation of a memory device according to an embodiment;

FIG. 2 shows a schematic representation of a memory controller according to another embodiment;

FIG. 3 shows a schematic representation of a hard drive according to another embodiment;

FIG. 4 shows a schematic representation of a hard drive controller according to another embodiment;

FIG. 5 shows a schematic representation of a relation between a file system and a storage device;

FIG. 6 shows a schematic representation of a portable memory medium;

FIG. 7 shows a schematic representation of a computer according to another embodiment;

FIG. 8 shows a schematic representation of a method according to another embodiment; and

FIG. 9 shows a schematic representation of a method according to another embodiment.

### DETAILED DESCRIPTION

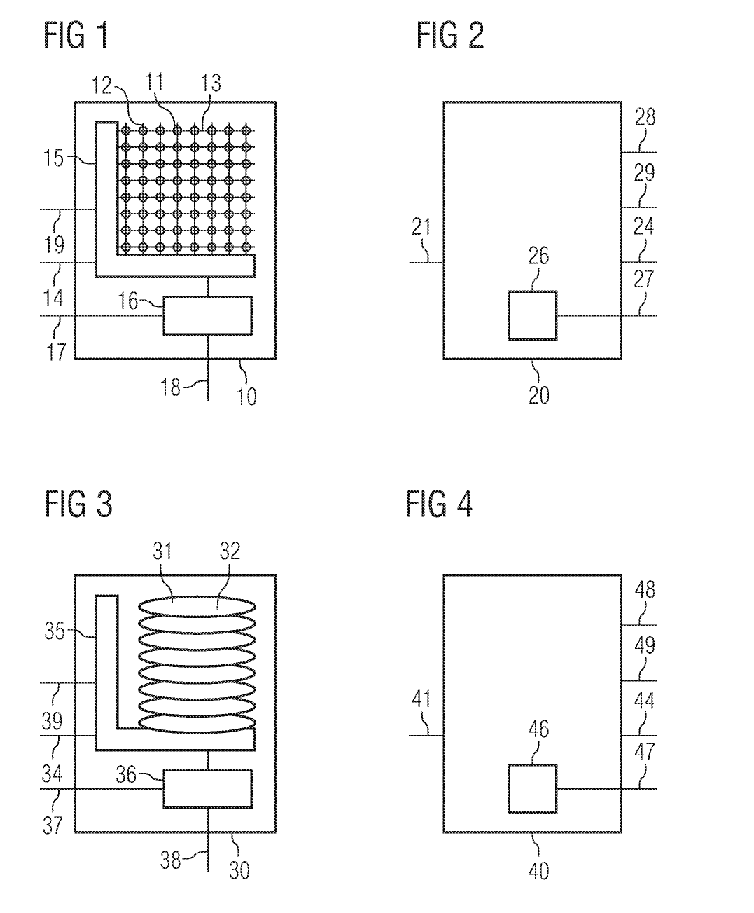

FIG. 1 shows a schematic representation of a memory device 10 comprising a rectangular array of memory cells 11. Each memory cell 11 is arranged at a cross-point between a word line 12 and a bit line 13. The number of memory cells 11, the number of word lines 12 and the number of bit lines 13 can deviate from the schematic representation of FIG. 1. Furthermore, the memory device 10 can comprise a number of arrays of memory cells 11. The memory cells 11 can be volatile or non-volatile memory cells of any kind, and the memory device 10 can be an SRAM, a DRAM, an MRAM, an FRAM, a PCRAM, a CBRAM, a ROM, a PROM, an EPROM, an EEPROM, or any other volatile or non-volatile memory.

The memory device 10 further comprises an address input 14, auxiliary circuits 15, a data conversion circuit 16, a format input 17, a data interface 18 and a command and control interface 19. The auxiliary circuits 15 comprise for example receivers, an address decoder, sense amplifiers etc. The auxiliary circuits 15 are coupled to the address input 14, to the command and control interface 19, to the word lines 12 and to the bit lines 13. Furthermore, the auxiliary circuits 15 are coupled to the data interface 18 via the data conversion circuit 16. The data conversion circuit 16 is further coupled to the format input 17. The address input 14, the format input 17, the data interface 18 and the command and control interface 19 are configured to be coupled to external circuitry, for example to a memory controller.

The address input 14 is configured to receive an address identifying one memory cell 11 or a group of memory cells 11. The data interface 18 is configured to receive data to be written to memory cells 11 and to transmit data read from memory cells 11. The command and control interface 19 is configured to receive commands and control signals and can be configured to transmit status information indicating the internal status of the memory device 10. An address received via the address input 14 is decoded by the auxiliary circuits 15, in particular by an address decoder comprised in the auxiliary circuits 15. One or several word lines 12 and one or several bit lines 13 are selected, or activated, responsive to the address. Data simultaneously received via the data interface 18 can be stored to the memory cell or memory cells 11 identified by the address. Data stored in the memory cell or in the memory cells 11 identified by the address can be read and transferred to external circuitry via the data interface 18.

Each of the address input 14, the format input 17, the data interface 18 and the command and control interface 19 can comprise a number of single inputs/outputs configured to receive or transmit, respectively, electrical, optical or other signals. Any two or three or all of the address input 14, the format input 17, the data interface 18 and the command and control interface 19 can be partly or completely integrated.

A vast number of different data formats exist for the storage or the transfer of text, sound, graphics, images, pictures, videos and other kinds of data. Examples of proprietary and non-proprietary data formats are bitmap (*.bmp), JPEG (*.jpeg, .jpg), tagged image file format (*.tif, *.tiff), portable document format (*.pdf), post script (*.ps), encapsulated postscript (*.eps), Microsoft Word® (*.doc), open document formats (*.odt, *.ods, *.odp, *.odg), waveform audio format (*.wav), moving picture experts group video and audio formats (*.mpg, *.mpeg, *.mp3) etc. Throughout this application, serializing or de-serializing a data stream is not understood as a data conversion. That is, reference to “data conversion” herein is exclusive of serializing or deserializing data.

Any kind of data can be received via the data interface 18 in any data format and stored in the memory cells 11 in the same data format. Data stored in the memory cells 11 in any data format can be transferred to external circuitry via the data interface 18 in the same data format. The data conversion circuit 16 is configured to optionally convert data from a first data format to a second data format. When data can be written to the memory cells 11 (this is, for example, not true for a read-only memory) the data conversion circuit 16 can be configured to convert data received via the data interface 18 in a first data format to a second data format and to transfer the data in the second data format to the memory cells 11. Additionally or as an alternative, the data conversion circuit 16 can be configured to convert data read from the memory cells 11 in a first data format to the second data format and to transfer the data in the second data format to the data interface 18.

The data conversion circuit 16 can be configured to perform one predetermined conversion from a predetermined first data format to a predetermined second data format on any data received via the data interface 18 or read from the memory cells 11, respectively. In this case, no format input 17 needs to be provided. When the format input 17 is provided, a signal indicating whether the predetermined conversion is to be performed or not can be received via the format input 17.

As an alternative, the data conversion circuit 16 is configured to perform a conversion from one predetermined original data format to any target data format selected from a predetermined group of data formats. In this case, the data conversion circuit 16 can be configured to receive a signal indicating the selected target data format via the format input 17. As a further alternative, the data conversion circuit 16 is configured to convert any original data format selected from a predetermined group of data formats to one predetermined target data format. In this case, the data conversion circuit 16 can be configured to receive a signal indicating the original data format via the format input 17. As a further alternative, the data conversion circuit 16 is configured to convert any original data format selected from a first predetermined group of data formats to any target data format selected from a second predetermined group of data formats, wherein the second predetermined group can be a function of the original data format. In this case, the data conversion circuit 16 can be configured to receive a signal indicating the kind of conversion, in particular indicating the original data format and the target data format via the format input 17. In any case, the data conversion circuit 16 can be configured to perform no conversion when a reading or writing process without conversion is indicated by the signal received via the format input 17.

The data conversion circuit 16 can be manufactured for one or several predetermined data conversion algorithms. As an alternative, the data conversion circuit 16 can be reconfigured after the manufacture. For this purpose, the data conversion circuit 16 can comprise one or several field programmable gate arrays or reconfigurable datapath arrays or other circuitry which can be reconfigured after the manufacture. As an alternative fuses are provided or firmware which can be updated or replaced.

FIG. 2 displays a schematic representation of a memory controller 20 comprising a first interface 21, an address output 24, a controlling circuit 26, a format output 27, a data interface 28 and a command and control interface 29. The first interface 21 of the memory controller 20 is configured to be coupled to external circuitry, for example to a processor of a computer. The first interface 21 is configured to receive command, address, control, data and other signals indicating an address of a storage location and optionally data to be read to this storage location. Furthermore, the first interface 21 of the memory controller 20 is configured to transmit, to external circuitry, data read from a storage location.

Although the memory controller 20 can be coupled to other memory devices, too, reference numerals referring to the embodiment described above with reference to FIG. 1 will be used in order to facilitate an understanding of the subsequent description. The address output 24, the format output 27, the data interface 28 and the command and control interface 29 of the memory controller 20 are configured to be coupled to an address input 14, a format input 17, a data interface 18 and a command and address interface 19, respectively, of a memory device. Any two or three or all of the address output 24, the format output 27, the data interface 28 and the command and control interface 29 of the memory controller 20 can be partly or completely integrated. Each of the address output 24, the format output 27, the data interface 28 and the command and control interface 29 can comprise one or several inputs and/or outputs for the reception or transmission of electrical, optical or other signals.

The controlling circuit 26 is configured to generate and transmit, via the format output 27, a format signal to one or several memory devices coupled to the memory controller 20, wherein the format signal is provided for controlling a format conversion within the memory device or the memory devices coupled to the memory controller 20.

One or several of the memory device 10 described above with reference to FIG. 1 and the memory controller 20 described above with reference to FIG. 2 can be combined in a system, for example in a computer as described below with reference to FIG. 7. As an example of the co-operation of the memory device 10 and the memory controller 20, a writing process will be described. In this case, the memory device can not be a read-only memory. The memory controller 20 receives, via its first interface 21, data in an original data format, an address and an indication of the original data format and an indication of a target data format. The memory controller 20 transfers a write command, the data, the address and a signal indicating the original data format and the target data format to at least one of the memory devices 10 coupled to the memory controller 20 via the command and control interface 29 of the memory controller 20 and the command and control interface 19 of the memory device 10; via the data interface 28 of the memory controller 20 and the data interface 18 of the memory device 10; via the address output 24 of the memory controller 20 and the address input 14 of the memory device 10; and via the format output 27 of the memory controller 20 and the format input 17 of the memory device 10, respectively. In the memory device 10, the data are converted from the original format to the target data format by the data conversion circuit 16. The auxiliary circuits 15 store the converted data in one or several memory cells 11 identified by the address.

As a further example, a reading process will be described. The memory controller 20 receives, via its first interface 21, an address and an indication of an original data format and a target data format. The read command, the address and a signal indicating the original data format and the target data format are transferred from the memory controller 20 to at least one memory device 10 coupled to the memory controller 20, wherein read command, the address and the signal indicating the original data format and the target data format are transferred via the command and control output 24 of the memory controller 20 and the command and control input 14 of the memory device 10; via the address output 24 of the memory controller 20 and the address input 14 of the memory device 10; and via the format output 27 of the memory controller 20 and the format input 17 of the memory device 10, respectively. In the memory device 10, data in the original data format are read from a memory cell or memory cells identified by the address. The data are converted from the original data format to the target data format by the data conversion circuit 26 and transferred to the memory controller 20 via the data interface 18 of the memory device 10 and the data interface 28 of the memory controller 20. The memory controller 20 provides the data in the target data format to the circuitry coupled to the memory controller 20 via the first interface 21.

FIG. 3 is a schematic representation of a hard drive 30 comprising one or several discs 31, for example discs 31 with a surface which can be magnetized. Data can be stored at a number of different storage locations 32 at the disc or the discs 31, wherein each the storage locations is identified by an address. The hard drive 30 further comprises an address input 34, auxiliary circuits 35, a data conversion circuit 36, a format input 37, a data interface 38 and a command and control interface 39.

The command and control interface 39 is configured to receive commands and control signals and can be configured to transmit status information indicating the internal status of the hard drive 30. The address input 34 of the hard drive 30 is configured to be coupled to a hard drive controller or any other external circuitry. The hard drive 30 is configured to receive address signals from the hard drive controller or other external circuitry, respectively, via the address input 34. The auxiliary circuits 35 comprises an address decoder, receivers, controller circuits driving the discs 31 and read and write heads not displayed in FIG. 3, amplifiers etc.

The data conversion circuit 36 is coupled between the auxiliary circuits 35 and the data interface 38 of the hard drive 30 and configured to convert data from an original data format to a target data format. The data conversion circuit 36 is further configured to receive a format signal via the format input 37. This format signal can indicate the original data format and/or the target data format. In particular, the data conversion circuit 36 can be configured to convert data read from the disc 31 or from one or several of the discs 31 in an original data format to a target data format and to transfer the data in the target data format to the data interface 38. Additionally or as an alternative, the data conversion circuit 36 can be configured to convert data received via the data interface 38 in an original data format to a target data format and to transfer the data in the target data format to the auxiliary circuits 35. Furthermore, the data conversion circuit 36 can be configured to encrypt or decrypt data read from the disc 31 or from one or several of the discs 31 and transfer the data to the data interface 38. Additionally, the data conversion circuit 36 can be configured to encrypt or decrypt data received via the data interface 38 and transfer the data to the auxiliary circuits 35.

The data conversion circuit 36 can be configured to convert data from a predetermined original data format to a predetermined target data format. In this case, no format input 37 needs to be provided. When the format input 37 is provided, a signal indicating whether the predetermined conversion is to be performed or not can be received via the format input 37.

As an alternative, the data conversion circuit 36 is configured to convert data from a predetermined original data format to any target data format selected from a predetermined group of data formats. In this case, the selected target data format is indicated or identified by a signal received via the format input 37. As a further alternative, the data conversion circuit 36 is configured to convert data from any original data format selected from a predetermined group of data formats to a predetermined target data format. In this case, the data conversion circuit 36 is configured to receive a signal indicating the original data format via the format input 37. As a further alternative, the data conversion circuit 36 is configured to convert any original data format selected from a first predetermined group of data formats to any target data format selected from a predetermined second group of data formats. In this case, the data conversion circuit 36 is configured to receive a signal indicating the type of conversion or the original data format and the target data format via the format input 37.

FIG. 4 shows a schematic representation of a hard drive controller 40 comprising a first interface 41, an address output 44, a controlling circuit 46, a format output 47, a data interface 48 and a command and control interface 49. The first interface 41 of the hard drive controller 40 is configured to be coupled to a processor or any other external circuitry and to receive command, address, control and data signals and a signal indicating a type of data conversion from the processor or external circuitry, respectively.

Although the hard drive controller 40 can be coupled to other hard drives, too, reference numerals referring to the embodiment described above with reference to FIG. 3 will be used in order to facilitate an understanding of the subsequent description. The address output 44, the format output 47, the data interface 48 and the command and control interface 49 of the hard drive controller 40 are configured to be coupled to an address input 34, a format input 37, a data interface 38 and a command and control interface 39, respectively, of one of several hard drives. The hard drive controller 40 is configured to transfer address signals identifying one or several storage locations in one or several hard drives via the address output 44, to transfer a format signal identifying one or several data formats via the format output 47, to transfer and receive data via the data interface 48 and to transfer and optionally receive command and control signals via the command and control interface 49. The controlling circuit 46 of the hard drive controller 40 is configured to generate a format signal indicating, or identifying, an original data format and/or a target data format and to transfer the format signal to one or several hard drives via the format output 47.

As an example, one or several hard drives 30 as described above with reference to FIG. 3 can be coupled to a hard drive controller 40 as described above with reference to FIG. 4. As an example of a co-operation of a hard drive controller 40 and a hard drive 30, a write process will be described. The hard drive controller 40 receives, via its first interface 41, a write command, data, an address and an indication of a target data format. The hard drive controller 40 processes and forwards the command, the data, the format signal and the address to the hard drive 30 coupled to the hard drive controller 40 via the command and control interface 49 of the hard drive controller 40 and the command and control interface 39 of the hard drive 30; via the data interface 48 of the hard drive controller 40 and the data interface 38 of the hard drive 30; via the format output 47 of the hard drive controller 40 and the format input 37 of the hard drive 30; and via the address output 44 of the hard drive controller 40 and the address input 34 of the hard drive 30, respectively. Controlled by the format signal received from the hard drive controller 40, the data conversion circuit 36 of the hard drive 30 converts the data received from the hard drive controller 40 from the original data format to the target data format indicated, or identified, by the format signal. Controlled by the address received from the hard drive controller 40, the auxiliary circuits 35 of the hard drive 30 write the data in the target data format to the storage location 32 identified by the address.

As a further example, the hard drive controller 40 receives, via its first interface 41, the read command, an address and an indication of a target data format. The hard drive controller 40 processes and forwards the command, the address and the indication of the original data format and/or the target data format via the command and control output 49 of the hard drive controller 40 and the command and control input 39 of the hard drive 30; via the address output 44 of the hard drive controller 40 and the address input 34 of the hard drive 30; and via the format output 47 of the hard drive controller 40 and the format input 37 of the hard drive 30, respectively. Controlled by the address received from the hard drive controller 40, the auxiliary circuits 35 of the hard drive 30 read data in an original data format from the storage location 32 identified by the address received from the hard drive controller 40. Controlled by the format signal, the data conversion circuit 36 converts the data read from the storage location 32 or the storage locations 32 to the target data format. The data are transferred to the hard drive controller 40 via the data interface 38 of the hard drive 30 and the data interface 48 of the hard drive controller 40. The hard drive controller 40 forwards the data via its first interface 41.

In both the memory device 10 described above with reference to FIG. 1 and the hard drive 30 described above with reference to FIG. 3 the storage locations are managed by external circuitry. Each of the memory device 10 described above with reference to FIG. 1 and the hard drive 30 described above with reference to FIG. 3 is configured to receive a read or write command and an address from external circuitry and to read data from or write data to, respectively, one or several storage locations identified by the address.

The memory device 10 described above with reference to FIG. 1 and the hard drive 30 described above with reference to FIG. 3 are examples of a storage device comprising one or several storage locations and a data conversion circuit configured to convert read data or data to be written from an original data format to a target data format on the fly. In further examples, the array of memory cells 11 or the discs 31, respectively, are replaced by other storage media, for example by a CD-ROM or a drive for a CD-ROM, a DVD or a drive for a DVD etc. Further examples of memory devices comprising a data conversion circuit as described above include a USB memory stick, other memory sticks or memory cards and other portable storage media.

Each of the storage device controllers described above with reference to the FIGS. 2 and 4 can be integrated with a processor or another component of a computer or other system. The memory controller 20 described above with reference to FIG. 2 and the hard drive controller 40 described above with reference to FIG. 4 are examples of storage device controllers configured to control the respective storage device and, in particular, a data conversion circuit in the respective storage device.

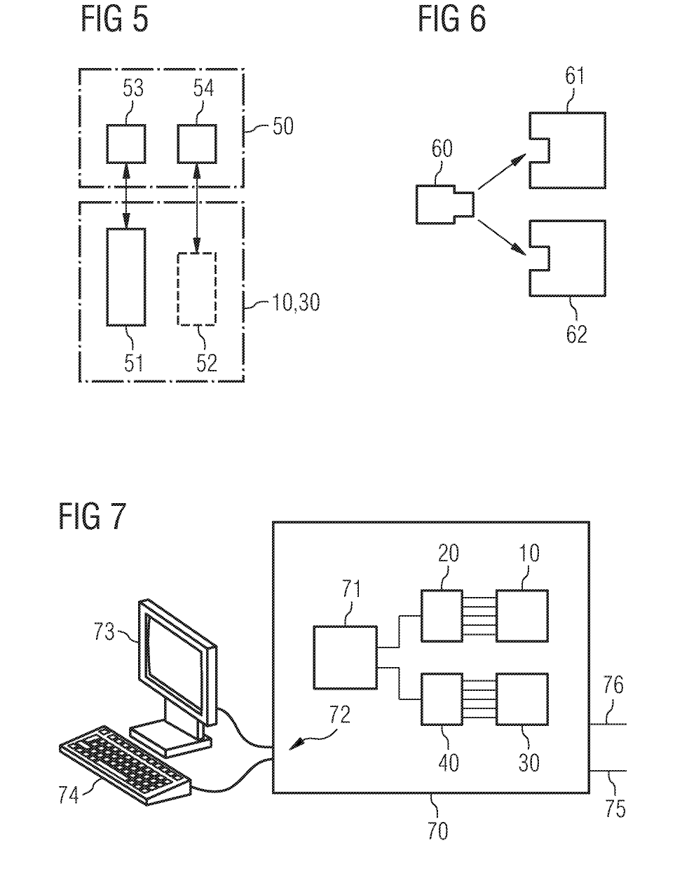

FIG. 5 is a schematic representation of the interrelation of a file system 50 and a storage device, for example a memory device 10 as described above with reference to FIG. 1 or a hard drive 30 as described above with reference to FIG. 3. A first file 51 containing data in a first data format is stored in the storage device 10, 30. The file system 50 is any kind of data base managing the content of the storage device 10, 30. The file system 50 can be part of an operating system of a laptop-computer, a personal computer, a workstation, a server or any other computer. The file system can be implemented as software or firmware or in hardware and can be part of the firmware or hardware of the storage device 10, 30, as well.

At a user interface (which can be part of the file system 50) or at an interface to other software or firmware, the file system 50 provides entries 53, 54. The entries represent the data stored in the storage device 10, 30 and allow for an access to these data. As can be seen from FIG. 5, the file system provides a first entry representing the first file 51 stored in the storage device 10, 30. In addition, the file system 50 provides a second entry 54 representing a second file 52 containing the data contained in the first file 51, wherein the second file contains the data in a second data format. Furthermore, a name may be associated with the first entry, wherein the name indicates the first data format, and a name may be associated with the second entry, wherein the name indicates the second data format.

In FIG. 5, the virtual second file 52 is represented by a broken line indicating that the second file is a virtual file and is, in fact, not stored in the storage device 10, 30 although the second entry 54 allows an access to the second file 52. In event of a read access to the second entry 54, the file system 50 causes an access to the first file 51 and a conversion of the data contained in the first file from the first data format to the second data format. This conversion can, for example, be performed on the fly in a data conversion circuit of the storage device 10, 30 or in circuitry external to the storage device 10, 30.

In event of a write access to the second entry 54, data provided in the second data format are converted to the first data format and stored in the first file 51 in the storage device 10, 30. Again, the conversion can be performed on the fly by a data conversion circuit of the storage device 10, 30 or by circuitry external to the storage device 10, 30.

When the first file 51 is generated in the storage device 10, 30, both the first and second entries 53, 54 are generated. When the second file 52 is altered or modified via an access to the second entry 54, the modification is, after a conversion to the first data format, applied to the first file 51.

The file system can be configured to store any data provided in any original data format selected from a predetermined group of data formats in the original data format or, independent from the original data format, in a predetermined data format. The file system can be configured to provide for any first file 51 containing data in an original data format selected from a predetermined group of data formats, a number of entries 53, 54 representing the data in a corresponding number of data formats. For example, the file system can be configured to provide, for a first file 51 containing data in any data format selected from a predetermined group of data formats, a number of entries, wherein each entry represents a second, third etc., file containing the same data in one of the data formats from the predetermined group of data formats. Therein, the number of entries corresponds to the number of data formats in the predetermined group of data formats.

The file system described above with reference to FIG. 5 can, for example, be part of an operating system of a personal computer, a notebook, a server, a workstation, a laptop computer, a palmtop computer or any other apparatus with a processor. As an alternative, the file system can be part of the firmware or the software of a memory device (for example the memory device 10 described above with reference to FIG. 1), of a hard drive (for example the hard drive 30 described above with reference to FIG. 3), of a portable memory medium, or of any other storage device.

FIG. 6 is a schematic representation of a portable memory medium 60 which can be coupled to at least a first apparatus 61 and a second apparatus 62. The portable memory medium 60 can be any of the portable memory media described above which can be alternatively coupled to a number of different apparatuses. For example, the portable memory medium 60 can be used for the exchange of data between the first apparatus 61 and the second apparatus 62. The portable memory medium 60 comprises the data conversion circuit similar to the data conversion circuits described above with reference to FIGS. 1 and 3.

Additionally or alternatively, a file system as described above with reference to FIG. 5 is comprised in the portable memory medium 60 or in at least one of the first apparatus 61 and the second apparatus 62. For example, the first apparatus 61 is a camera producing digital images in the RAW format. The portable memory medium 60 comprises a data conversion circuit as described above with reference to the FIGS. 1 and 3. When a photograph is generated by the camera 61, the photograph is stored as a file in the RAW format in the portable memory medium. In the portable memory medium, one entry representing the file in the RAW format, one entry representing a file containing the photograph in the JPEG format in a high resolution and one entry representing a file containing the photograph in the JPEG format in a low resolution is provided. When the portable memory medium 60 is coupled to a second apparatus 62, for example a personal computer, both the first, second and third entries are provided to the second apparatus. In event of a read access from the second apparatus 62 to the second or third entry, the first file is read from the storage location of the portable memory medium 60 and the data contained in the first file are converted, on the fly, to the JPEG format in high or low resolution, respectively. When this conversion is conducted by a data conversion circuit within the portable memory medium, a file containing the photograph as high or low resolution JPEG data is then transferred to the second apparatus 62.

FIG. 7 is a schematic representation of a system comprising the memory device 10 as described above with reference to FIG. 1, a memory controller 20 as described above with reference to FIG. 2, a hard drive as described above with reference to FIG. 3 and a hard drive controller 40 as described above with reference to FIG. 4. Furthermore, the system 70 comprises a processor 71 and an interface 72 configured to be coupled to a monitor 73 and a keyboard 74 forming a user interface. Furthermore, the system 70 comprises a network interface 75 configured to be coupled to a computer network and a bus interface 76 configured to be coupled to a bus, for example to an IEEE488 Bus. The monitor 73 and the keyboard 74 can be part of the system and integrated with the system 70. The network interface 75 and the bus interface 76 are optional.

The system 70 shown in FIG. 7 is, for example a personal computer, a laptop computer, a palmtop computer, a workstation, a server or any other computer. As an alternative embodiment, the system 70 comprises the memory device 10 and the memory controller 20 but does not comprise the hard drive 30 and the hard drive controller 40. As a further alternative, the system 70 comprises the hard drive 30 and the hard drive controller 40 but does not comprise the memory device 10 and the memory controller 20. In any case, the system 70 can comprise further components not shown in FIG. 7.

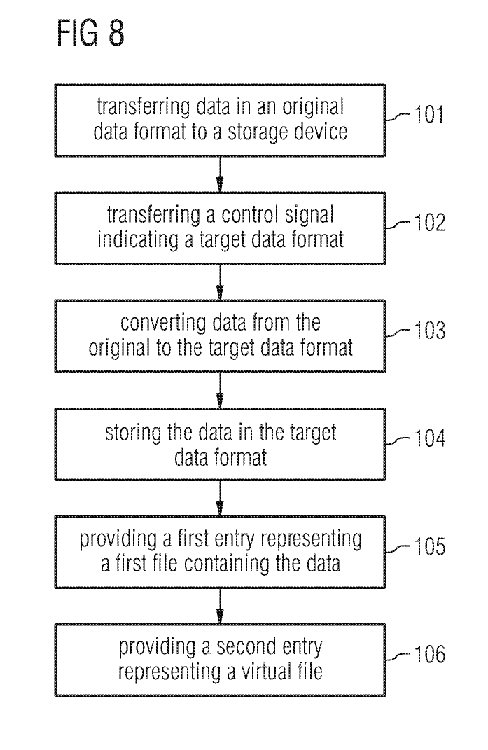

FIG. 8 is a schematic flow chart of a method of storing data in a storage device. In a first step 101, data are transferred to a storage device, for example to a storage device as described above with reference to FIG. 1. In the first step 101, the data are transferred in an original data format. In a second step 102, a control signal indicating a target data format or both the original data format and the target data format is transferred to the storage device. The second step 102 can be conducted before or after the first step or simultaneously with the first step 101. The second step 102 can be omitted, for example when all the data are converted to the same target format.

In a third step 103, the data transferred to the storage device are converted from the original data format to the target data format identified by the control signal within the storage device. In a fourth step 104, the data are stored in the target data format, at one or several storage locations within the storage device. The storage location can be identified by an address transferred to the storage device before the fourth step 104.

In an optional fifth step 105, an entry representing a first file containing the data in the target data format is provided by a file system. In a further optional sixth step 106 one or several additional entries are provided by the file system. Each of the additional entries represents a virtual file containing the same data in a different data format. The virtual files represented by the additional entries are not stored in the storage device. An access to one of the additional entries causes an access to the first file and a conversion of the data contained in the first file to the data format represented by the respective entry.

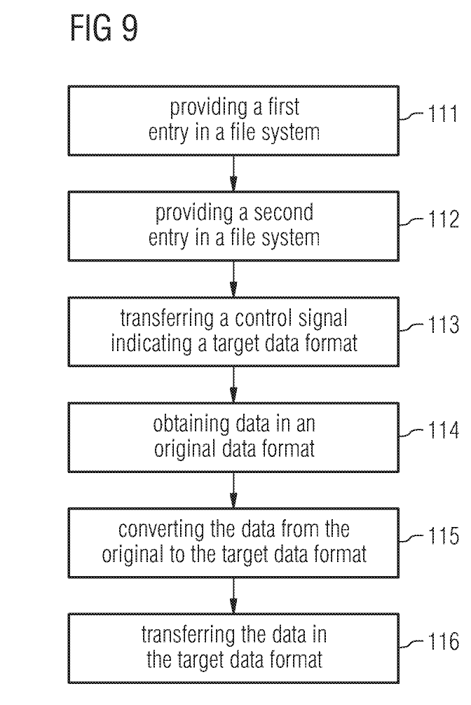

FIG. 9 is a schematic flow chart of a method of reading data from a storage device. In an optional first step 111 and in an optional second step 112, a first entry and a second entry, respectively, are provided by a file system. The first entry represents a first file stored in the storage device and containing data in a first data format. The second entry represents a virtual second file containing the same data in a second data format. The virtual file is not stored in the storage device.

In a third step 113 a control signal indicating a target data format or indicating the first data format and the target data format is transferred to the storage device. The third step 113 can be omitted, for example when all the data are converted to the same target format. In a fourth step 114 data, in an original data format, are obtained from a storage location of the storage device. In a fifth step 115 the data are converted from the original data format to the target data format identified by the control signal. In a sixth step 116 the converted data are transferred from the storage device to another device, for example to a storage device controller or a processor.

When the first and second steps 111, 112 have been conducted at any point in time prior to the third to sixth steps 113 to 116, the third through sixth steps 113 to 116 can be caused by an access to the second entry. In this case the second data format mentioned above with reference to the second step 112 is equal to the target data format mentioned above with reference to the fifth and sixth steps 115, 116.

Both methods described above with reference to the FIGS. 8 and 9 can be applied to each of the storage devices and each of the systems described above with reference to the FIGS. 1 to 7. Both the third step 103 of the method described above with reference to FIG. 8 and the fifth step 115 of the method described above with reference to FIG. 9 can be conducted by means of one of the data conversion circuits 16, 36 described above. As already mentioned, the second step 102 of the method described above with reference to FIG. 8 and the third step 113 of the method described above with reference to FIG. 9 are optional. For example no control signal is transferred when any data are converted to the same target data format or when the original data format is detected automatically and a predetermined target data format is assigned to the original data format. Furthermore, both methods can be applied to any system with a file system as described above with reference to FIG. 5.

The preceding description describes advantageous exemplary embodiments of the invention. The features disclosed therein and the claims and the drawings can, therefore, be useful for realizing the invention in its various embodiments, both individually and in any combination. While the foregoing is directed to embodiments of the present invention, other and further embodiments of this invention may be devised without departing from the basic scope of the invention, the scope of the present invention being determined by the claims that follow.

What is claimed is:

1. A storage device, comprising:
a storage location;
an interface coupled to the storage location, for an exchange of data between the storage device and external circuitry coupled to the interface; and
a data conversion circuit for converting data from a first data format to a second data format, the data conversion circuit being coupled to the storage location and to the interface;
wherein the data conversion circuit is configured to convert at least one of:
(1) data read from the storage location before they are transferred to the interface; and
(2) data received via the interface before they are written to the storage location.

2. The storage device as claimed in claim 1, further comprising an address input receiving address signals from external circuitry.

3. The storage device as claimed in claim 1, wherein the storage device is configured for a management of the storage location by external circuitry.

4. The storage device as claimed in claim 1, wherein the interface is configured for a control by external circuitry.

5. The storage device as claimed in claim 1, wherein the data conversion circuit is configured to transfer data from the storage location to the interface, or vice versa, without converting the data.

6. The storage device as claimed in claim 1, wherein the data conversion circuit is configurable.

7. The storage device as claimed in claim 6, wherein the storage location is configured for storing entire files.

8. The storage device as claimed in claim 1, wherein the first and second data formats are file formats for at least one of text, graphics, pictures, images, photographs, videos and sound.

9. The storage device as claimed in claim 1, wherein the data conversion circuit is an encrypting or decrypting circuit.

10. The storage device as claimed in claim 1, wherein the storage device is a main memory for a computer.

11. The storage device as claimed in claim 1, wherein the storage device is a portable memory medium connectable to other devices and provided for exchange of data between the other devices.

12. The storage device as claimed in claim 1, wherein the storage device is a memory device.

13. The storage device as claimed in claim 1, wherein the storage device is a memory card.

14. The storage device as claimed in claim 1,
wherein the storage device provides a file system implemented in at least one of hardware and firmware,
wherein the file system, for a first file containing data in the first data format, provides a first entry representing the first file and a second entry representing a virtual second file comprising of the data in the second data format.

15. The storage device as claimed in claim 14, wherein a name of the first entry indicates the first data format and a name of the second entry indicates the second data format.

16. The storage device as claimed in claim 14, wherein, responsive to the first file being accessed via the second entry, the data of the first file are converted from the first data format to the second data format and outputted as an actual second file comprising the data in the second data format.

17. A storage controller, comprising:
an interface for being coupled to a storage device; and
a controlling circuit managing the storage device coupled to the interface,
wherein the storage controller is configured to control a data conversion circuit integrated in the storage device coupled to the interface.

18. A system, comprising:
a storage controller; and
a storage device, the storage device comprising:
a storage location;
an interface coupled to the storage location, for an exchange of data between the storage device and the storage controller connected to the interface; and
a data conversion circuit for converting data from a first data format to a second data format, the data conversion circuit being coupled to the storage location and to the interface;
wherein the data conversion circuit is configured to convert at least one of data read from the storage location before they are transferred to the interface and data received via the interface before they are written to the storage location,
wherein the storage controller is configured to manage the storage location of the storage device and to control the data conversion circuit of the storage device.

19. The system as claimed in claim 18, wherein the system is a computer, the computer further comprising:
a processor;
at least one of an interface for exchange of data between the computer and a network;
an interface for exchange of data between the computer and a user interface; and
an interface for exchange of data between the computer and another apparatus.

20. A method of storing data in a storage device, the method comprising:
transferring the data in a first data format to the storage device;
converting the received data from the first data format to a second data format in the storage device; and
storing the data in the second data format in the storage device.

21. The method as claimed in claim 20, wherein the storing procedure is controlled by circuitry external to the storage device.

22. The method as claimed in claim 20, the method further comprising:
transferring a control signal to the storage device before the step of converting, the control signal indicating the second data format.

23. The method as claimed in claim 20, further comprising:
providing a first entry in a file system, the first entry representing a first file comprising the data in the second data format, the first file being stored in the storage device; and
providing a second entry in the file system, the second entry representing a virtual second file.

24. A method of reading data from a storage device, the method comprising:
obtaining the data in a first data format from a storage location in the storage device;
converting the obtained data from the first data format to a second data format in the storage device; and
transferring the data in the second data format from the memory device to an external circuit via an interface of the storage device.

25. The method as claimed in claim 24, the method further comprising:
transferring a control signal to the storage device before the step of converting, the control signal identifying the second data format.

26. The method as claimed in claim 24, further comprising:
providing a first entry in a file system, the first entry representing a first file comprising the data in the first data format, the first file being stored in the storage device;
providing a second entry in the file system, the second entry representing a virtual second file;
receiving a control signal identifying a reading access to the second entry,
wherein the step of converting is conducted in response to the control signal,
wherein the step of transferring the data comprises transferring an actual second file comprising the data in the second data format.

27. A file system for a storage device, wherein the file system, for a first file stored in the storage device and comprising data in a first data format being convertible to a second data format, provides a first entry representing the first file and a second entry representing a virtual second file comprising the data in the second data format.

28. The file system as claimed in claim 27, wherein a name of the first entry indicates the first data format and a name of the second entry indicates the second data format.

29. The file system as claimed in claim 27, wherein, responsive to the file being accessed via the second entry, the data of the file are converted from the first data format to the second data format and outputted as an actual second file comprising the data in the second data format.

30. A storage device, comprising:
means for storing data;
means for an exchange of data between the storage device and external circuitry; and
means for converting at least one of data read from the means for storing before the data are transferred to the means for exchange, and data received via the means for exchange before the data are written to the means for storing.
